(19) United States
(12) Patent Application Publication
(10) Pub. No.: US 2024/0413368 A1
(43) Pub. Date: Dec. 12, 2024

(54) RECHARGEABLE METAL BATTERY

(71) Applicants: HYUNDAI MOTOR COMPANY, SEOUL (KR); KIA CORPORATION, SEOUL (KR); UIF (UNIVERSITY INDUSTRY FOUNDATION), YONSEI UNIVERSITY, SEOUL (KR)

(72) Inventors: Yun Su Lee, Yongin-si (KR); Ji Hoon Jang, Suwon-si (KR); Dongil Lee, Goyang-si (KR); Yongsung Jo, Seoul (KR); Eunsaem Park, Seoul (KR)

(21) Appl. No.: 18/529,783

(22) Filed: Dec. 5, 2023

(30) Foreign Application Priority Data
Jun. 9, 2023 (KR) 10-2023-0074257

(51) Int. Cl. H01M 8/18; H01M 4/86; H01M 4/90; H01M 4/92; H01M 8/0247; H01M 8/083

(52) U.S. Cl. CPC H01M 8/188; H01M 4/8621; H01M 4/9041; H01M 4/926; H01M 8/0247; H01M 8/083

(57) ABSTRACT

A rechargeable metal battery with an improved efficiency, and a hydrogen generation and carbon dioxide storage system equipped with the same battery. A metal battery according to one embodiment includes an electrode unit including a metal electrode, a discharging unit disposed on a first side of the electrode unit; a charging unit disposed on a second side of the electrode unit, a first ion exchange membrane interposed between the electrode unit and the discharging unit, and a second ion exchange membrane interposed between the electrode unit and the charging unit.

### CROSS REFERENCE TO RELATED APPLICATIONS

The present application claims priority to Korean Patent Application No. 10-2023-0074257, filed Jun. 9, 2023, the entire contents of which is incorporated herein for all purposes by this reference.

### BACKGROUND

### 1. Field of the Disclosure

The present disclosure is directed to a rechargeable metal battery with improved efficiency and a hydrogen generation and carbon dioxide storage system equipped with the same battery.

### 2. Description of the Related Art

Traditional metal batteries may cause trouble due to their structure in which a single electrode acts as both an oxidation electrode and a reduction electrode.

Oxygen that is generated during battery charging corrodes the carbon carrier that carries the active metal, thereby deteriorating the performance and durability of the battery. In addition, since the material constituting the oxidation electrode and the material constituting the reduction electrode must exist together, the electrode construction is complicated, and the battery cannot sufficiently exhibit their given performance due to the occurrence of an overvoltage when the battery operates.

Moreover, since oxygen and hydrogen occur in the same space, there is a risk that the two gases will mix and cause ignition, explosion, etc.

### SUMMARY

In one aspect, the present disclosure provides a reliably operable, rechargeable metal battery.

In another aspect, the present disclosure provides a rechargeable metal battery with improved efficiency.

The objectives of the present disclosure are not limited the ones described above. The above and other objectives of the present disclosure will become more apparent from the following description and will be realized by means recited in the claims and combinations of the means.

To solve the above-mentioned problems occurring in the related art, the present disclosure discloses a method for manufacturing a perovskite solar cell module encapsulated with a self-cleaning thin film, and a perovskite solar cell module with a self-cleaning function, manufactured by the method.

A metal battery according to one embodiment of the present disclosure includes an electrode unit including a metal electrode, a discharging unit disposed on a first side of the electrode unit; a charging unit disposed on a second side of the electrode unit, a first ion exchange membrane interposed between the electrode unit and the discharging unit, and a second ion exchange membrane interposed between the electrode unit and the charging unit. The discharging unit may include a first space with a predetermined size, a first electrolyte accommodated in the first space, and a reduction electrode immersed at least partially in the first electrolyte. The charging unit may include a second space with a predetermined size, a second electrolyte accommodated in the second space, and an oxidation electrode immersed at least partially in the second electrolyte. The electrode unit may include a third space with a predetermined size, a third electrolyte accommodated in the third space, and the metal electrode immersed at least partially in the third electrolyte.

The metal electrode may include at least one selected from the group consisting of zinc (Zn), aluminum (Al), and combinations thereof.

The reduction electrode may include a support and a catalytic metal loaded on the carrier.

The oxidation electrode may include nickel foam.

The discharging unit may further include a first body plate having a plate shape, a reduction electrode current collector disposed on a first surface of the first body plate and having a sheet shape, and a first spacer having a frame shape and interposed between the reduction electrode current collector and the first ion exchange membrane to define the first space. The reduction electrode may be disposed on the first surface of the reduction electrode current collector.

The first spacer may include a first electrolyte inlet formed to pass through a first portion of a flank of the first spacer and configured to enable communication between the first space and an external environment, and a first electrolyte outlet formed to pass through a second portion of the flank of the first spacer and configured to enable communication between the first space and the external environment, the second portion being spaced from the first portion.

The charging unit may further include a second body plate having a plate shape, an oxidation electrode current collector disposed on a first surface of the second body plate and having a sheet shape, and a second spacer having a frame shape and interposed between the oxidation electrode current collector and the second ion exchange membrane to define the second space. The oxidation electrode may be disposed on the first surface of the oxidation electrode current collector.

The second spacer may include: a second electrolyte inlet formed to pass through a first portion of a flank of the second spacer and configured to enable communication between the second space and the external environment, and a second electrolyte outlet formed to pass through a second portion of the flank of the second spacer and configured to enable communication between the second space and the external environment, the first portion being spaced from the second portion.

The electrode unit may further include an electrode current collector having a sheet shape, a third spacer interposed between the metal electrode current collector and the first ion exchange membrane, and a fourth spacer interposed between the metal electrode current collector and the second ion exchange membrane. The third spacer and the fourth spacer form the third space, and the metal electrode may be disposed on both surfaces of the metal electrode current collector.

Each of the third space and the fourth spacer may include a third electrolyte inlet formed to pass through a first portion of a flank of the spacer and configured to enable communication between the third space and the external environment; and a third electrolyte outlet formed to pass through a second portion of the flank of the spacer and configured to enable communication between the third space and the external environment, the first portion being spaced from the second portion.

The first space and the third space may be separated by the first ion exchange membrane, and the second space and the third space may be separated by the second ion exchange membrane.

The first ion exchange membrane may include a cation exchange membrane, and the second ion exchange membrane may comprise a cation exchange membrane.

The first ion exchange membrane may include a cation exchange membrane, and the second ion exchange membrane may comprise an anion exchange membrane.

The first electrolyte may include water and bicarbonate.

The second electrolyte may include at least one selected from the group consisting of potassium hydroxide (KOH), sodium hydroxide (NaOH), and combinations thereof.

The third electrolyte may include at least one selected from the group consisting of potassium hydroxide (KOH), sodium hydroxide (NaOH), and combinations thereof.

The metal battery may be configured such that, upon discharging, a reaction represented by the following reaction formula 1 occurs at the electrode unit a reaction represented by the following reaction formula 2 occurs at the discharging unit.

M(s)+aOH⁻(aq)->M(OH)ₐ^{b-}(aq)+(a−b)^{e-} Reaction Formula 1

In reaction formula 1, M may include at least one selected from the group consisting of lithium (Li), sodium (Na), magnesium (Mg), zinc (Zn), aluminum (Al), and combinations thereof.

Where a may be an integer in a range of 1 to 5.

Where b may be a value (a—oxidation number of M) obtained by subtracting an oxidation number of M from a.

2H⁺(aq)+2e⁻→H₂(g) Reaction Formula 2

The metal battery may be configured such that, upon charging, a reaction represented by the following reaction formula 3 occurs at the electrode unit a reaction represented by the following reaction formula 4 occurs at the charging unit.

M(OH)ₐ^{b-}(aq)+(a−b)e⁻->M(s)+aOH⁻(aq) Reaction Formula 3

In reaction formula 3, M may include at least one selected from the group consisting of lithium (Li), sodium (Na), magnesium (Mg), zinc (Zn), aluminum (Al), and combinations thereof.

Where a may be an integer in a range of 1 to 5.

Where b may be a value (a—oxidation number of M) obtained by subtracting an oxidation number of M from a.

4OH⁻(aq)→O₂(g)+2H₂O(1)+4e⁻ Reaction Formula 4

In another aspect of the present disclosure, there is provided a hydrogen generation and carbon dioxide storage system including a metal battery, a first electrolyte circulation unit connected to the metal battery and configured to receive the first electrolyte discharged from the discharging unit, separate hydrogen contained in the first electrolyte, and to supply the first electrolyte to the discharging unit, a second electrolyte circulation unit connected to the metal battery and configured to receive the second electrolyte discharged from the charging unit, to separate oxygen contained in the second electrolyte, and to supply the second electrolyte to the charging unit, and a third electrolyte circulation unit connected to the metal battery and configured to receive the third electrolyte discharged from the electrode unit and to supply the third electrolyte to the electrode unit.

According to the present disclosure, it is possible to obtain a reliably operable, rechargeable metal battery.

According to the present disclosure, it is possible to obtain a rechargeable metal battery with improved efficiency.

The advantages of the present disclosure are not limited to the ones described above. It should be understood that the advantages of the present disclosure include all effects that can be inferred from the description given below.

### BRIEF DESCRIPTION OF THE FIGURES

FIG. 1 shows a metal battery according to a related art;

FIG. 2 shows a hydrogen generation and carbon dioxide storage system according to a first embodiment of the present disclosure;

FIG. 3 shows a hydrogen generation and carbon dioxide storage system according to a second embodiment of the present disclosure;

FIG. 4 shows a metal battery according to one embodiment of the present disclosure;

FIG. 5A shows a first spacer;

FIG. 5B shows a second spacer;

FIG. 5C shows a third spacer;

FIG. 5D shows a fourth spacer;

FIG. 6 shows a result of a comparison between the performance of a metal battery of Example 1 and the performance of a metal battery of Comparative Example; and

FIG. 7 shows measurements of performance of a metal battery of Example 2.

### DETAILED DESCRIPTION

Above objectives, other objectives, features, and advantages of the present disclosure will be readily understood from the following preferred embodiments associated with the accompanying drawings. However the present disclosure is not limited to the embodiments described herein and may be embodied in other forms. The embodiments described herein are provided so that the disclosure can be made thorough and complete and that the spirit of the present disclosure can be fully conveyed to those skilled in the art.

Throughout the drawings, like elements are denoted by like reference numerals. In the accompanying drawings, the dimensions of the structures are larger than actual sizes for clarity of the present disclosure. Terms used in the specification, “first”, “second”, etc., may be used to describe various components, but the components are not to be construed as being limited to the terms. These terms are used only for the purpose of distinguishing a component from another component. For example, without departing from the scope of the present disclosure, a first component may be referred as a second component, and a second component may be also referred to as a first component. As used herein, the singular forms “a”, “an”, and “the” are intended to include the plural forms as well unless the context clearly indicates otherwise.

It will be further understood that the terms “comprises”, “includes”, or “has” when used in this specification specify the presence of stated features, regions, integers, steps, operations, elements and/or components, but do not preclude the presence or addition of one or more other features, regions, integers, steps, operations, elements, components and/or combinations thereof. It will also be understood that when an element such as a layer, film, area, or sheet is referred to as being “on” another element, it can be directly on the other element, or intervening elements may be present therebetween. Similarly, when an element such as a layer, film, area, or sheet is referred to as being “under” another element, it can be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

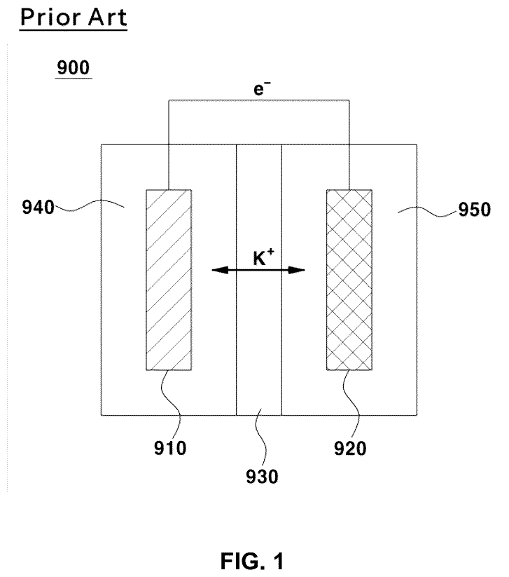

FIG. 1 shows a metal battery according to a related art. A conventional metal battery 900 includes a first electrode 910, a second electrode 920, and an ion exchange membrane 930 interposed between the first electrode 910 and the second electrode 920. The first electrode 910 may be immersed in a first electrolyte 940, and the second electrode 920 may be immersed in a second electrolyte 950. The first electrode 910 may include zinc (Zn). The second electrode 920 may include a metal foam and an active metal supported on a carrier. For example, the second electrode 920 may be a structure in which platinum supported on a carbon carrier is applied to a metal foam.

In the conventional metal battery 900, the second electrode 920 serves as both a reduction electrode and an oxidation electrode. Upon discharging, the first electrode 910 ionizes to Zn(OH₄)²⁻ and generates electrons. The electrons migrate to the second electrode 920, and hydrogen is generated at the second electrode 920. In this case, the second electrode 920 acts as a reduction electrode. Upon charging, the Zn(OH₄)²⁻ is reduced to zinc, and at the second electrode 920, water in the second electrolyte 950 is electrochemically decomposed to produce oxygen. In this case, the second electrode 920 acts as an oxidation electrode.

In the conventional metal battery 900, hydrogen and oxygen are generated at the second electrode 920 upon charging and discharging, respectively. When oxygen is generated at the second electrode 920, the carbon carrier of the second electrode 920 may be corroded. As a result, the performance and lifetime of the conventional metal battery 900 may be degraded. Furthermore, the construction of the second electrode 920 is complicated, and overvoltage is highly likely to occur, because it is necessary to combine the metal foam and platinum supported on the carbon carrier so that the second electrode 920 can act as both an oxidation electrode and a reduction electrode. In addition, since hydrogen and oxygen are generated in the same space on the second electrode 920, there is a risk that the two gases will mix and cause ignition, explosion, etc.

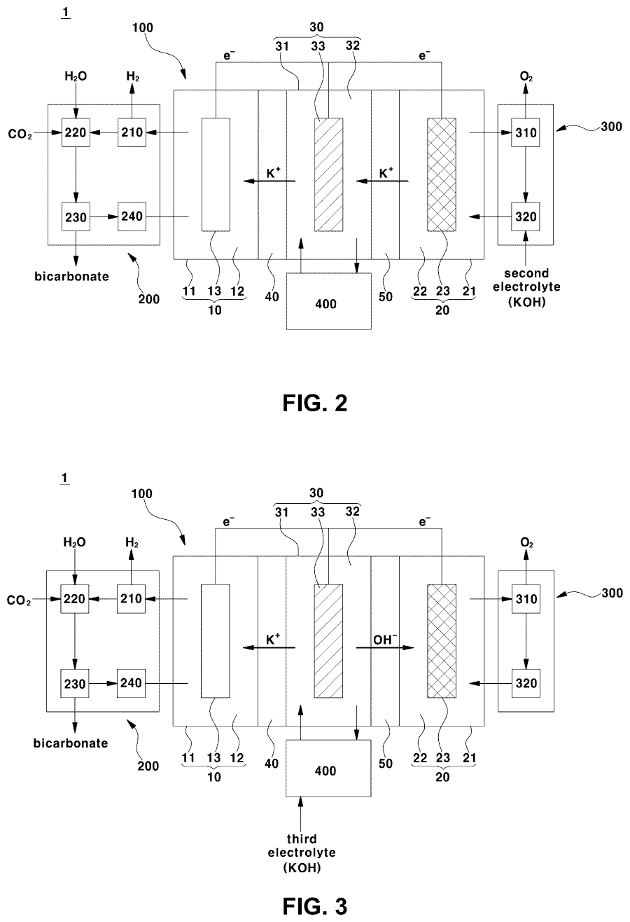

The present disclosure aims to solve the above problems of the related art, and is characterized by a metal battery composed of three electrodes so that discharging and charging sections are separated from each other. FIG. 2 shows a hydrogen generation and carbon dioxide storage system according to a first embodiment of the present disclosure. The hydrogen generation and carbon dioxide storage system 1 includes: a first electrolyte circulation unit 200 separating hydrogen and bicarbonate from a first electrolyte discharged from the metal battery 100 and supplying the first electrolyte back to the metal battery 100; a second electrolyte circulation unit 300 separating oxygen from a second electrolyte discharged from the metal battery 100 and supplying the second electrolyte back to the metal battery 100; and a third electrolyte circulation unit 400 receiving a third electrolyte discharged from the metal battery 100 and supplying the third electrolyte back to the metal battery 100.

The metal battery 100 may include an electrode unit 30, a discharging unit 10 disposed on a first side of the electrode unit 30, a charging unit 20 disposed on a second side of the electrode unit 30, a first ion exchange membrane 40 interposed between the electrode unit 30 and the discharging unit 10, and a second ion exchange membrane 50 interposed between the electrode unit 30 and the charging unit 20.

The first embodiment of the system shown in FIG. 2 is characterized in that the first ion exchange membrane 40 and the second ion exchange membrane 50 are cation exchange membranes.

The discharging unit 10 may include a first space 11 of a predetermined size, a first electrolyte 12 accommodated in the first space 11, and a reduction electrode 13 at least partially immersed in the first electrolyte 12.

The first space 11 may be an internal space of an object having a predetermined shape, such as a container, or may be a space defined by neighboring parts that are combined. The shape, size, etc. of the first space 11 is not particularly limited.

The first electrolyte 12 contain water as a main component. After dissolving carbon dioxide in the water contained in the first electrolyte circulation unit 200, which will be described later, the products may be stored in the first space 11.

When carbon dioxide is dissolved in water, hydrogen cations and bicarbonate anions are generated according to reaction formula: CO₂(g)+H₂O(1)→H⁺(aq)+HCO₃⁻(aq). The hydrogen cations meet electrons at the reduction electrode 13, which will be described later, to become hydrogen gas, and the bicarbonate anions react with potassium cations (K+) or sodium cations (Na+) that have moved through the first ion exchange membrane 40 into the first space 11 to become bicarbonate.

Thus, the first electrolyte 12 may contain water, unreacted carbon dioxide, hydrogen gas, and bicarbonate.

The reduction electrode may include a support and a catalytic metal loaded on the carrier. The shape of the reduction electrode 13 is not particularly limited and is, for example, a sheet shape having a predetermined thickness.

The support is not particularly limited and may contain at least one selected from the group consisting of, but not limited to, carbon paper, carbon fiber, carbon felt, carbon black, carbon cloth, metallic foam, metallic thin film, and combinations thereof. The catalytic metal is not particularly limited in type and may include, for example, platinum (Pt).

The discharging unit 20 may include a second space 21 of a predetermined size, a second electrolyte 22 accommodated in the second space 21, and an oxidation electrode 23 at least partially immersed in the second electrolyte 22.

The second space 21 may be an internal space of an object having a predetermined shape, such as a container, or may be a space defined by neighboring parts that are combined. The shape, size, etc. of the second space 21 are not particularly limited.

The second electrolyte 22 contains water as a main component. Preferably, the second electrolyte 22 includes at least one selected from the group consisting of potassium hydroxide (KOH), sodium hydroxide (NaOH), and combinations thereof. The second electrolyte 22 may include an aqueous solution of potassium hydroxide (KOH), an aqueous solution of sodium hydroxide (NaOH), or the like. The concentration of the potassium hydroxide (KOH), sodium hydroxide (NaOH), etc. is not particularly limited and may be, for example, in a range of 3 M to 6 M. Assuming that the second electrolyte 22 is an aqueous solution of potassium hydroxide (KOH), the potassium hydroxide may be present in the form of potassium cations (K+) and hydroxide ions (OH−). The potassium cations (K+) move through the second ion exchange membrane 50 to the electrode unit 30, and the hydroxide ions (OH−) changes into oxygen gas, water, and electrons at the oxidation unit 23. This will be described later.

Accordingly, the second electrolyte 22 may further include oxygen gas in addition to the main component.

The oxidation electrode 23 may include nickel foam. The shape of the oxidation electrode 23 is not particularly limited and is, for example, a sheet shape having a predetermined thickness.

The electrode unit 30 may include a third space 31 of a predetermined size, a third electrolyte 32 accommodated in the third space 31, and a metal electrode 33 at least partially immersed in the third electrolyte 32.

The third space 31 may be an internal space of an object having a predetermined shape, such as a container, or may be a space defined by neighboring parts that are combined. The shape, size, etc. of the second space 31 are not particularly limited.

The third electrolyte 32 may contain an alkali metal hydroxide as a main component. Preferably, the third electrolyte 23 includes at least one selected from the group consisting of potassium hydroxide (KOH), sodium hydroxide (NaOH), and combinations thereof.

The metal electrode 33 may include any material capable of ionizing and generating electrons in the third electrolyte 32. For example, the metal electrode 33 may contain at least one selected from the group consisting of lithium (Li), sodium (Na), magnesium (Mg), zinc (Zn), aluminum (Al), and combinations thereof. Preferably, the metal electrode 33 may include at least one selected from the group consisting of magnesium (Mg), zinc (Zn), aluminum (Al), and combinations thereof. Magnesium (Mg), zinc (Zn), and aluminum (Al) are stable in water. Therefore, the metal electrode may be preferably disposed in in a water-based system. More preferably, the metal electrode 33 may include at least one selected from the group consisting of magnesium (Mg), zinc (Zn), aluminum (Al), and combinations thereof. Yet more preferably, Zinc (Zn) and aluminum (Al) may be included, given world reserves and prices.

The shape of the metal electrode 33 is not particularly limited and is, for example, a sheet shape having a predetermined thickness.

Assuming that the metal electrode 33 is zinc (Zn), upon discharging of the metal battery 100, the zinc (Zn) changes to zinc ions, Zn(OH)₄²⁻. Accordingly, the third electrolyte 32 may further include zinc ions, Zn(OH)₄²⁻.

The metal electrode 33 may be electrically connected to the reduction electrode 13 via a conductor or the like. The metal electrode 33 may be electrically connected to the oxidation electrode 23 via a conductor or the like. Accordingly, electrons E generated by the reaction in the metal battery 100 can move among the reduction electrode 13, the oxidation electrode 23, and the metal electrode 33 via the conductors or the like.

The first ion exchange membrane 40 and the second ion exchange membrane 50 may each include a cation exchange membrane. The cation exchange membrane may be made of a cation-conductive material. The cation-conductive material is not particularly limited in type. Examples of the cation-conductive material include perfluorosulfonic acid-based polymers such as Nafion, ion transfer materials such as Nasicon, and the like.

The first ion exchange membrane 40 may allow movement of cations between the first space 11 and the third space 31 but blocks movement of the first electrolyte 12 and the third electrolyte 32.

The second ion exchange membrane 50 may allow movement of cations between the second space 21 and the third space 31 but blocks movement of the second electrolyte 22 and the third electrolyte 32.

The first electrolyte circulation unit 200 may include a hydrogen separator 210, a reactor 220, a filtering device 230, and a first electrolyte feeder 240.

The hydrogen separator 210 may separate hydrogen contained in the first electrolyte 12 discharged from the discharging unit 10. The hydrogen separator 210 may include a gas-liquid separation device for separating hydrogen gas.

The reactor 220 may be disposed downstream of the hydrogen separator 210. In the reactor 220, carbon dioxide that is externally fed can be dissolved in water. The water may include water contained in the first electrolyte 12 and/or externally supplied water. Hydrogen cations and bicarbonate anions are dissolved in the first electrolyte 12 through a dissolution reaction of carbon dioxide, expressed by the reaction formula of CO₂(g)+H₂O(1)→H⁺(aq)+HCO₃⁻(aq), and supplied to the first space 11 through the downstream devices. The hydrogen cations are converted to hydrogen gas at the reduction electrode 13, and the bicarbonate anions are converted to alkaline bicarbonate at the reduction electrode 13. This will be described in greater detail below.

The filtering device 230 may be disposed downstream of the reactor 220 and separate alkaline bicarbonate contained in the first electrolyte 12 as a precipitate. The filter 230 may include a cooler to reduce the temperature of the first electrolyte 12 to cause the precipitation of alkaline bicarbonate, and a filter to filter out the precipitated alkaline bicarbonate.

The first electrolyte feeder 240 may be disposed downstream of the filtering device 230, and may send the first electrolyte 12 from which hydrogen gas and alkali bicarbonate have been removed back to the first space 11.

The second electrolyte circulation unit 300 may include an oxygen separator 310 and a second electrolyte feeder 320.

The oxygen separator 310 may separate oxygen contained in the second electrolyte 22 discharged from the charging unit 20. The oxygen separator 310 may include a gas-liquid separation device for separating oxygen gas.

The second electrolyte feeder 320 may be disposed downstream of the oxygen separator 310, and may send the second electrolyte 12 from which oxygen gas and alkali bicarbonate has been removed back to the second space 22.

Since the second electrolyte 22 is ionized and consumed during charging and discharging of the metal battery 100, a fresh second electrolyte may be supplied to the second electrolyte feeder 320 from the outside.

The third electrolyte circulation unit 400 may receive the third electrolyte 32 discharged from the electrode unit 30 and send the third electrolyte 32 back to said third space 31 so that the third electrolyte 32 can be circulated.

During the discharging operation of the metal battery 100, the metal electrode 33 of the electrode unit 30 is ionized by the third electrolyte 32, and the reaction represented by the following reaction formula 1 can occur.

M(s)+aOH⁻(aq)->M(OH)ₐ^{b-}(aq)+(a−b)e⁻ Reaction Formula 1

In reaction formula 1, M may include at least one selected from the group consisting of lithium (Li), sodium (Na), magnesium (Mg), zinc (Zn), aluminum (Al), and combinations thereof.

Where a may be an integer in a range of 1 to 5.

Where b may be a value (a—oxidation number of M) obtained by subtracting an oxidation number of M from a.

A non-limiting example of reaction formula 1 can be at least one of reaction formulas 1-1 to Formula 1-5 below.

Zn(s)+40H⁻(aq)→Zn(OH)₄²⁻(aq)+2e⁻ Reaction Formula 1-1

Li(s)+OH⁻(aq)→LiOH(aq)+e⁻ Reaction Formula 1-2

Na(S)+OH⁻(aq)→NaOH(aq)+e⁻ Reaction Formula 1-3

Mg(s)+20H⁻(aq)→Mg(OH)₂(aq)+2e⁻ Reaction Formula 1-4

Zn(s)+30H⁻(aq)→Zn(OH)₂_{^{−}}(aq)+3e⁻ Reaction Formula 1-5

The alkaline cations, K+ or Na+, of the third electrolyte 32 move through the first ion exchange membrane 40 to the discharge unit 10, where the alkaline cations react with the bicarbonate ions (HCO3⁻) contained in the first electrolyte 12 to produce alkaline bicarbonate. The alkaline bicarbonate may be separated and recovered from the first electrolyte circulation unit 200 as described above.

The electrons generated according to reaction formula 1 are transferred to the reduction electrode 13 through a conductor, and the reaction represented by the following reaction formula 2 can occur at the reduction electrode 13.

2H⁺(aq)+2e⁻→H₂(g) Reaction Formula 2

The hydrogen gas generated according to reaction formula 2 can be separated and recovered from the first electrolyte circulation unit 200 as described above.

When the metal battery 100 is charged, M(OH)ₐ^{b-}(aq) generated as in reaction formula 1 react with the electrons having migrated to the metal electrode 33 from the oxidation electrode 23, thereby being reduced to M(s) through the reaction of the following reaction formula 3.

M(OH)ₐ^{b-}(aq)+(a−b)e⁻->M(s)+aOH⁻(aq) Reaction Formula 3

In reaction formula 3, M, a, and b refer to the same as in reaction formula 1.

A non-limiting example of reaction formula 3 can be at least one of reaction formulas 3-1 to 3-5 below.

Zn(OH)₄²⁻(aq)+2e⁻→Zn(s)+OH⁻(aq) Reaction Formula 3-1

LiOH(aq)+e⁻→Li(s)+OH⁻(aq) Reaction Formula 3-2

NaOH(aq)+e⁻→Na(S)+OH⁻(aq) Reaction Formula 3-3

Mg(OH)₂(aq)+2e⁻→Mg(s)+2OH⁻(aq) Reaction Formula 3-4

Al(OH)₃(aq)+3e⁻→Al(s)+3OH⁻(aq) Reaction Formula 3-5

The electrons are generated by the following reaction formula 4 occurring at the oxidation electrode 23.

40H⁻(aq)→O₂(g)+2H₂O(1)+4e⁻ Reaction Formula 4

Since the hydroxide ions are consumed, the alkaline cations, K+ or Na+, contained in the second electrolyte 22 may migrate through the second ion exchange membrane 50 to the electrode unit 30.

The third electrolyte 32 of the electrode unit 30 may be circulated through the third electrolyte circulation unit 500 for ionization and reduction control of the metal electrode 33 during charging and discharging of the metal battery.

FIG. 3 shows a hydrogen generation and carbon dioxide storage system according to a second embodiment of the present disclosure. The second embodiment of the system shown in FIG. 3 features that a first ion exchange membrane 40 and a second ion exchange membrane 50 are a cation exchange membrane and an anion exchange membrane, respectively.

The configuration of the second embodiment is the same as that of the first embodiment except for the first ion exchange membrane 40 and the second ion exchange membrane 50. Therefore, a redundant description of the same parts will be omitted.

The first electrolyte membrane 40 may include a cation exchange membrane. The cation exchange membrane may be made of a cation-conductive material. The cation-conductive material is not particularly limited in type. Examples of the cation-conductive material include perfluorosulfonic acid-based polymers such as Nafion, ion transfer materials such as Nasicon, and the like.

The first ion exchange membrane 40 may allow movement of cations between the first space 11 and the third space 31 but blocks movement of the first electrolyte 12 and the third electrolyte 32.

The second electrolyte membrane 50 may include an anion exchange membrane. The anion exchange membrane may be made of an anion-conductive material. The anion-conductive material is not particularly limited. For examples, the anion-conductive material includes at least one selected from the group consisting of poly(terphenylene), 1,4-diazabicyclo [2,2,2] octane-poly(ether sulfone), poly(aryl piperidinium), poly(phenylene oxide)-block-poly(vinyl benzyl trimethyl ammonium), and combinations thereof.

The second ion exchange membrane 50 may allow movement of anions between the second space 21 and the third space 31 but blocks movement of the second electrolyte 22 and the third electrolyte 32.

During the discharging operation of the metal battery 100, the metal electrode 33 of the electrode unit 30 is ionized by the third electrolyte 32, and the reaction represented by the following reaction formula 1 can occur.

M(s)+aOH⁻(aq)->M(OH)ₐ^{b-}(aq)+(a−b)e⁻ Reaction Formula 1

In reaction formula 1, M may include at least one selected from the group consisting of lithium (Li), sodium (Na), magnesium (Mg), zinc (Zn), aluminum (Al), and combinations thereof.

Where a may be an integer in a range of 1 to 5.

Where b may be a value (a—oxidation number of M) obtained by subtracting an oxidation number of M from a.

A non-limiting example of reaction formula 1 can be at least one of reaction formulas 1-1 to 1-5 above.

The alkaline cations, K+ or Na+, of the third electrolyte 32 move through the first ion exchange membrane 40 to the discharge unit 10, where the alkaline cations react with the bicarbonate ions (HCO3⁻) contained in the first electrolyte 12 to produce alkaline bicarbonate. The alkaline bicarbonate may be separated and recovered from the first electrolyte circulation unit 200 as described above.

The electrons generated according to reaction formula 1 are transferred to the reduction electrode 13 through a conductor, and the reaction represented by the following reaction formula 2 can occur at the reduction electrode 13.

2H⁺(aq)+2e⁻->H₂(g) Reaction Formula 2

The hydrogen gas generated according to reaction formula 2 can be separated and recovered from the first electrolyte circulation unit 200 as described above.

When the metal battery 100 is charged, M(OH)ₐ^{b-}(aq) generated as in reaction formula 1 react with the electrons having migrated to the metal electrode 33 from the oxidation electrode 23, thereby being reduced to M(s) through the reaction of the following reaction formula 3.

M(OH)ₐ^{b-}(aq)+(a−b)e⁻->M(s)+aOH⁻(aq) Reaction Formula 3

In reaction formula 3, M, a, and b refer to the same as in reaction formula 1.

A non-limiting example of reaction formula 3 can be at least one of reaction formulas 3-1 to 3-5 above.

The hydroxide ions may migrate through the second ion exchange membrane 50 to the charging unit 20. At the oxidation electrode 23, the reaction represented by reaction formula 4 may occur.

40H⁻(aq)→O₂(g)+2H₂O(1)+4e⁻ Reaction Formula 4

The electrons migrate to the metal electrode 33 via a conductor connected to the oxidation electrode 23 and react according to reaction formula 3.

The third electrolyte 32 of the electrode unit 30 is consumed because alkaline cations K+ or Na+ and hydroxide ions move through the first ion exchange membrane 40 and the second ion exchange membrane 50 to the discharging unit 10 and the charging unit 20, respectively, during charging and discharging of the battery. Therefore, the third electrolyte circulation portion 400 may be replenished with a fresh third electrolyte from the outside.

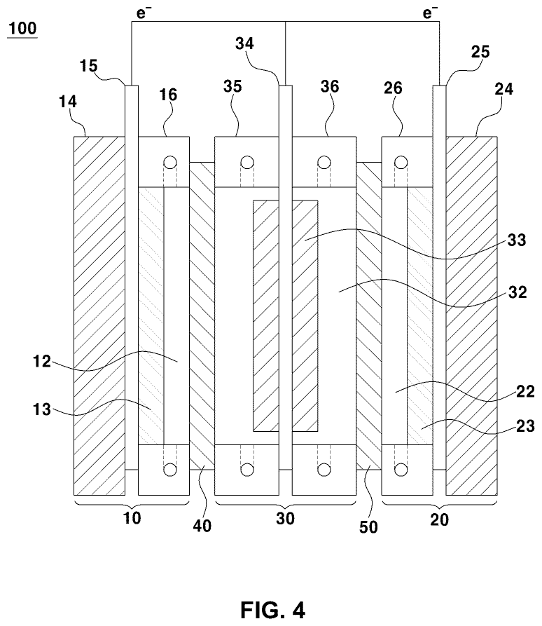

FIG. 4 shows a metal battery according to one embodiment of the present disclosure. The metal battery 100 may include a discharging unit 10, a charging unit 20, an electrode unit 30, a first ion exchange membrane 40 interposed between the discharging unit 10 and the electrode unit 30, and a second ion exchange membrane 50 interposed between the charging unit 20 and the electrode unit 30.

The discharging unit 10 may include a first body plate 14 having a plate shape, a reduction electrode current collector 15 disposed on a first face of the first body plate 14 and having a sheet shape, and a first spacer 16 having a frame shape and interposed between the reduction electrode current collector 15 and the first ion exchange membrane 40 to define the first space 11.

The reduction electrode 13 may be disposed on a first surface of the reduction electrode current collector 15.

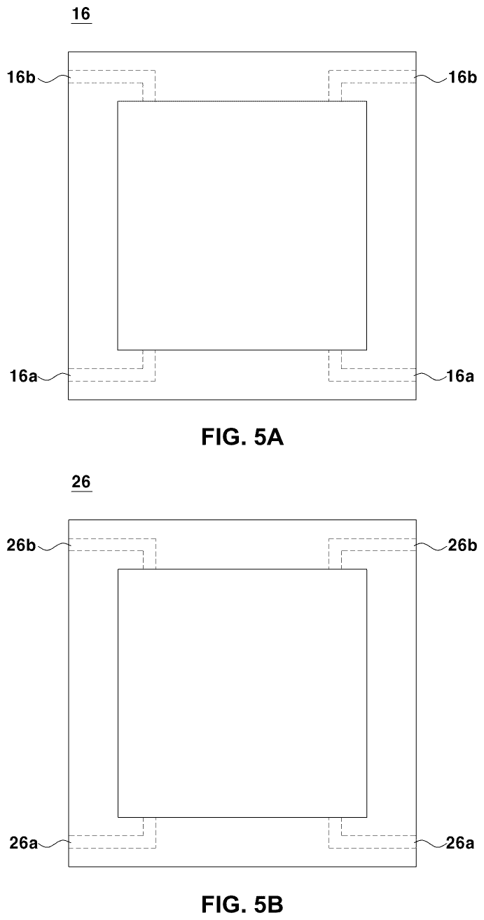

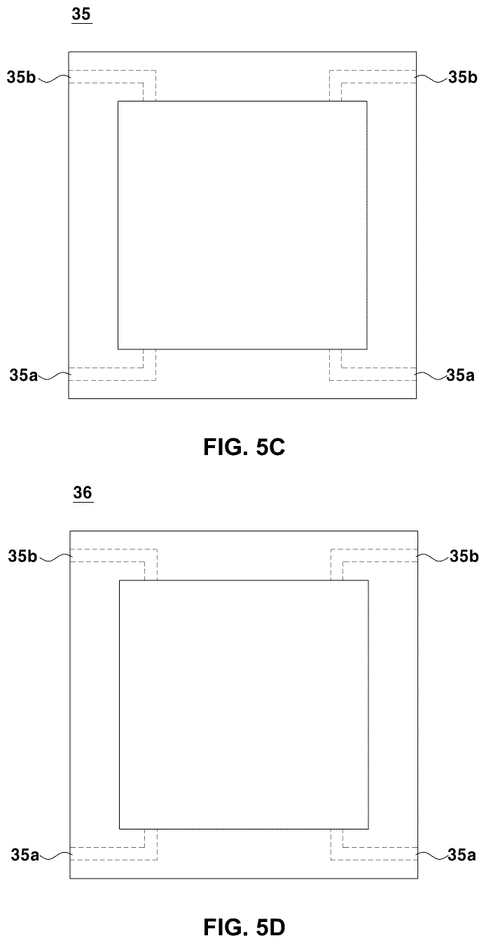

FIG. 5A shows the first spacer 16. The first spacer 16 may include a first electrolyte inlet 16a formed to pass through a first portion of a flank thereof and configured to enable communication between the first space 11 and an external environment, and a first electrolyte outlet 16b formed to pass through a second portion of the flank thereof and configured to enable communication between the first space 11 and the external environment, the second portion being spaced from the first portion.

The charging unit 20 may include: a second body plate 24 having a plate shape, an oxidation electrode current collector 25 disposed on a first surface of the second body plate 24 and having a sheet shape, and a second spacer 26 having a frame shape and interposed between the oxidation electrode current collector 25 and the second ion exchange membrane 50 to define the second space 21.

The oxidation electrode 23 may be disposed on a first surface of the oxidation electrode current collector 25.

FIG. 5B shows the second spacer 26. The second spacer 26 may include a second electrolyte inlet 26a formed to pass through a first portion of a flank thereof and configured to enable communication between the second space 21 and the external environment, and a second electrolyte outlet 26b formed to pass through a second portion of the flank thereof and configured to enable communication between the second space 21 and the external environment, the second portion being spaced from the first portion.

The electrode unit 30 may include a sheet-shaped metal electrode current collector 34, a third spacer 35 interposed between the metal electrode current collector 34 and the first ion exchange membrane 40, and a fourth spacer 36 interposed between the metal electrode current collector 34 and the second ion exchange membrane 50.

The third spacer 35 and fourth spacer 36 may form the third space 31.

The metal electrode 33 may be disposed on both surfaces of the metal electrode current collector 34.

FIG. 5C shows the third spacer 35. The third spacer 35 may include a third electrolyte inlet 35a formed to pass through a first portion of a flank thereof and configured to enable communication between the third space 31 and the external environment, and a third electrolyte outlet 35b formed to pass through a second portion of the flank thereof and configured to enable communication between the third space 31 and the external environment, the second portion being spaced from the first portion.

FIG. 5D shows the fourth spacer 36. The fourth spacer 36 may include a third electrolyte inlet 35a formed to pass through a first portion of a flank thereof and configured to enable communication between the third space 31 and the external environment, and a third electrolyte outlet 35b formed to pass through a second portion of the flank thereof and configured to enable communication between the third space 31 and the external environment, the second portion being spaced from the first portion.

Other forms of the disclosure will be described in more detail with reference to examples described below. The examples described below are presented only to help understanding of the present disclosure, and the scope of the present disclosure is not limited thereto.

### Example 1

A metal battery as shown in FIG. 3 was prepared. A cation exchange membrane was used as a first ion exchange membrane and an anion exchange membrane was used as a second ion exchange membrane. A reduction electrode was platinum on a carbon support (Pt/C), an oxidation electrode was nickel foam, and a metal electrode was zinc (Zn). A first electrolyte was an aqueous solution containing 3 M of KHCO₃, and second and third electrolytes were an aqueous solution containing 6 M of KOH.

### Example 2

A metal battery as shown in FIG. 2 was prepared. A first ion exchange membrane and a second ion exchange membrane were a cation exchange membrane. The remaining parts of the configuration was the same as in Example 1.

### Comparative Example

A conventional metal battery as shown in FIG. 1 was prepared. An ion exchange membrane was a cation exchange membrane. A first metal was zinc (Zn), and a second metal was platinum supported on a carbon support (Pt/C), which was applied to nickel foam.

A first electrolyte was an aqueous solution containing 6 M of KOH, and a second electrolyte was an aqueous solution containing 3 M of KHCO₃.

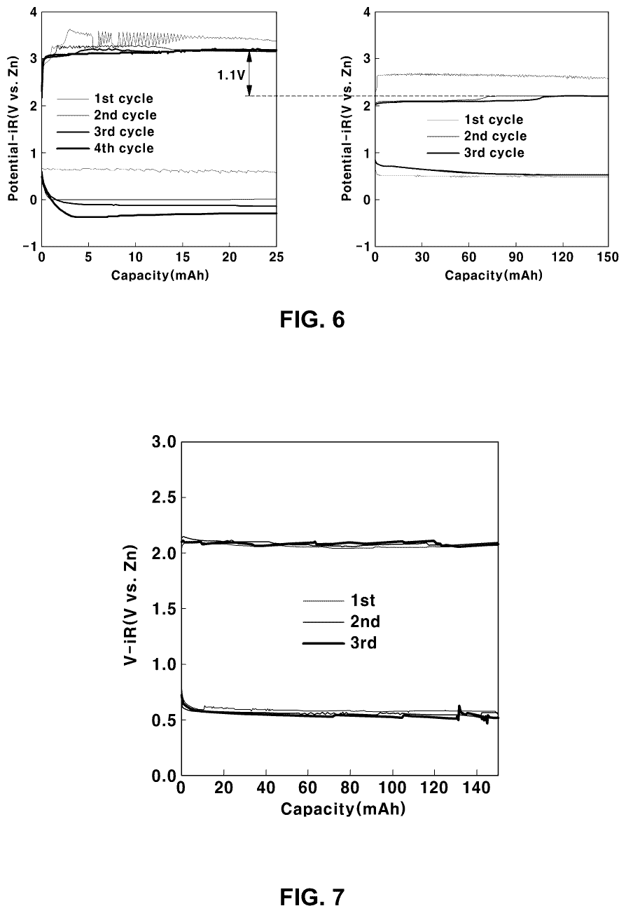

FIG. 6 shows a result of performance comparison between the metal battery of Example 1 and the metal battery of Comparative Example. The left side of the figure represents the performance of the metal battery of Comparative Example and the right side of the figure represents the performance of the metal battery of Example 1. In the case Comparative Example, the voltage increases, and the operating state becomes unstable over charging and discharging cycles. These phenomena result from the corrosion of the carbon carrier. The metal battery of Example 1 has a higher charging efficiency than the metal battery of Comparative Example because the voltage is about 1.1V lower. Furthermore, it is confirmed that the charging and discharging of the battery of Example 1 proceeds stably compared to the battery of Comparative Example.

FIG. 7 shows measurements of performance of a metal battery of Example 2. The battery of Example 2 shows equivalent performance to that of Example 1, with a voltage of about 2.1 V when charging. It is confirmed that the battery of Example 2 is stably charged and discharged.

Although examples and experimental examples according to the present disclosure have been described for illustrative purposes, those skilled in the art will appreciate that various modifications, additions and substitutions are possible, without departing from the scope and spirit of the disclosures as defined in the appended claims

The invention claimed is:

1. A metal battery comprising:
an electrode unit comprising a metal electrode;
a discharging unit positioned at a first side of the electrode unit;
a charging unit positioned at a second side of the electrode unit;
a first ion exchange membrane positioned between the electrode unit and the discharging unit; and
a second ion exchange membrane positioned between the electrode unit and the charging unit;
wherein the discharging unit comprises a first space of a predetermined size, a first electrolyte accommodated in the first space, and a reduction electrode at least partially immersed in the first electrolyte;
wherein the charging unit comprises a second space of a predetermined size, a second electrolyte accommodated in the second space, and an oxidation electrode at least partially immersed in the second electrolyte; and
wherein the electrode unit comprises a third space of a predetermined size, a third electrolyte accommodated in the third space, and the metal electrode at least partially immersed in the third electrolyte.

2. The metal battery of claim 1, wherein the metal electrode comprises at least one selected from the group consisting of lithium (Li), sodium (Na), magnesium (Mg), zinc (Zn), aluminum (Al), and combinations thereof.

3. The metal battery of claim 1, wherein the reduction electrode comprises a support and a catalytic metal loaded on the support.

4. The metal battery of claim 1, wherein the oxidation electrode comprises nickel foam.

5. The metal battery of claim 1, wherein the discharging unit further comprises:
a first body plate with a plate shape;
a reduction electrode current collector positioned on a first surface of the first body plate and having a sheet shape; and
a first spacer having a frame shape and positioned between the reduction electrode current collector and the first ion exchange membrane to define the first space,
wherein the reduction electrode is positioned on a first surface of the reduction electrode current collector.

6. The metal battery of claim 5, wherein the first spacer comprises:
a first electrolyte inlet extending through a first portion of a flank of the first spacer, and configured to enable communication between the first space and an external environment; and
a first electrolyte outlet extending through a second portion of the flank of the first spacer, and configured to enable communication between the first space and the external environment, the second portion being spaced from the first portion.

7. The metal battery of claim 1, wherein the charging unit further comprises:
a second body plate with a plate shape;
an oxidation electrode current collector positioned on a first surface of the second body plate and having a sheet shape; and
a second spacer having a frame shape and positioned between the oxidation electrode current collector and the second ion exchange membrane to define the second space;
wherein the oxidation electrode is positioned on a first surface of the oxidation electrode current collector.

8. The metal battery of claim 7, wherein the second spacer comprises:
a second electrolyte inlet extending through a first portion of a flank of the second spacer, and configured to enable communication between the second space and an external environment; and
a second electrolyte outlet extending through a second portion of the flank of the second spacer, and configured to enable communication between the second space and the external environment, the second portion being spaced from the first portion.

9. The metal battery of claim 1, wherein the electrode comprises:
a metal electrode current collector having a sheet shape;
a third spacer positioned between the metal electrode current collector and the first ion exchange membrane; and
a fourth spacer positioned between the metal electrode current collector and the second ion exchange membrane;
wherein the third spacer and the fourth spacer form the third space; and
wherein the metal electrode is positioned on both surfaces of the metal electrode current collector.

10. The metal battery of claim 9, at least one of the third spacer and the fourth spacer comprises:
a third electrolyte inlet extending through a first portion of a flank of the corresponding spacer, and configured to enable communication between the third space and an external environment; and
a third electrolyte outlet extending through a second portion of the flank of the corresponding spacer, and configured to enable communication between the third space and the external environment, the first portion being spaced apart from the second portion.

11. The metal battery of claim 1, wherein the first space and the third space are separated from each other by the first ion exchange membrane, and
wherein the second space and the third space are separated from each other by the second ion exchange membrane.

12. The metal battery of claim 1, wherein the first ion exchange membrane comprises a cation exchange membrane, and
the second ion exchange membrane comprises a cation exchange membrane.

13. The metal battery of claim 1, wherein the first ion exchange membrane comprises a cation exchange membrane, and
the second ion exchange membrane comprises an anion exchange membrane.

14. The metal battery of claim 1, wherein the first electrolyte comprises water and bicarbonate.

15. The metal battery of claim 1, wherein the second electrolyte comprises at least one selected from the group consisting of potassium hydroxide (KOH), sodium hydroxide (NaOH), and combinations thereof.

16. The metal battery of claim 1, wherein the third electrolyte comprises at least one selected from the group consisting of potassium hydroxide (KOH), sodium hydroxide (NaOH), and combinations thereof.

17. The metal battery of claim 1, wherein upon discharging, a reaction represented by reaction formula 1 occurs at the electrode unit, and a reaction represented by reaction formula 2 occurs at the discharging unit, wherein reaction formula 1 is
M(s)+aOH⁻(aq)->M (OH)ₐ^{b-}(aq)+(a−b) e⁻, wherein in reaction formula 1, M comprises at least one selected from the group consisting of lithium (Li), sodium (Na), magnesium (Mg), zinc (Zn), aluminum (Al), and combinations thereof,
a is an integer in a range of 1 to 4, and
b is a value obtained by subtracting an oxidation number of M from a; and
wherein reaction formula 2 is 2H⁺(aq)+2e⁻→H₂ (g).

18. The metal battery of claim 1, wherein upon charging, a reaction represented by reaction formula 3 occurs at the electrode unit, and a reaction represented by reaction formula 4 occurs at the charging unit, wherein reaction formula 3 is
M(OH)ₐ^{b-}(aq)+(a−b)e⁻->M(s)+aOH⁻(aq),
wherein in reaction formula 3, M comprises at least one selected from the group consisting of lithium (Li), sodium (Na), magnesium (Mg), zinc (Zn), aluminum (Al), and combinations thereof,
a is an integer in a range of 1 to 4, and
b is a value obtained by subtracting an oxidation number of M from a; and
wherein reaction formula 4 is 4OH⁻(aq)->O₂(g)+2H₂O(1)+4e⁻

19. A hydrogen generation and carbon dioxide storage system comprising:
the metal battery of claim 1;
a first electrolyte circulation unit connected to the metal battery to receive the first electrolyte discharged from the discharging unit, the first electrolyte circulation unit being configured to separate hydrogen contained in the first electrolyte and to supply the first electrolyte to the discharging unit;
a second electrolyte circulation unit connected to the metal battery to receive the second electrolyte discharged from the charging unit, the second electrolyte circulation unit being configured to separate oxygen contained in the second electrolyte and to supply the second electrolyte to the charging unit; and
a third electrolyte circulation unit connected to the metal battery configured to receive the third electrolyte discharged from the electrode unit and to supply the third electrolyte to the electrode unit.
